(19) United States
(12) Patent Application Publication
(10) Pub. No.: US 2004/0076798 A1
(43) Pub. Date: Apr. 22, 2004

(54) Embossed high flexible paper and a method of producing the same

(76) Inventors: Nils-Ake Larsson, (US); Tord Johansson, G?auml;vle (SE)

Correspondence Address: BACON & THOMAS, PLLC, 625 SLATERS LANE, FOURTH FLOOR, ALEXANDRIA, VA, 22314

(21) Appl. No.: 10/470,742

(22) PCT Filed: Feb. 8, 2002
(86) PCT No.: PCT/SE02/00221

(30) Foreign Application Priority Data
Feb. 12, 2001 (SE) 0100434-0

(51) Int. Cl. B32B 1/00; B32B 29/08

(52) U.S. Cl. 428/153

(57) ABSTRACT

An embossed paper (10), wherein the paper is a highly extensible Kraft paper (10′) and wherein discrete bosses (14) and/or depressions (12) consist of portions of said paper stretched at a dry content of 50-95% is disclosed. A two, three or multi-layer paperboard comprising at least one layer of the embossed and/or depressed paper (10) is also disclosed. Thus, the embossed paper may be used as such or instead of fluted paper in a corrugated board. The disclosed paperboard is easily creased and folded in both major directions, and in other direction as well. Method of producing the embossed paper (10) and a method or producing a two, three or multi-layer paperboard comprising at least one layer of the embossed and/or depressed paper (10) are also described.

The present invention relates to an embossed high flexible paper, named bubble board, and a method of producing that embossed paper. More precisely, the invention relates to an embossed highly extensible Kraft paper that has discrete bosses and/or depressions consisting of portions of said paper stretched at a dry content of 50-95%. This paper may be used as such or in two, three or multi-layer paperboards substituting conventional fluted paper in corrugated board.

### BACKGROUND

Corrugated board is frequently used in the production of boxes and packages of different types and sizes. The common feature of all types of corrugated board is that they Consist of one or more layers of fluted paper stuck to one layer or between several layers of flat paper (facings).

It would be desirable to produce a similar type of board but with more equal properties in the machine direction and the cross-machine direction.

### SHORT DESCRIPTION OF THE INVENTION

The present invention provides an embossed paper that may be used as such or as a bulking layer in a two, three or multi-layer paperboard with one or more bulking layers. The embossed paper of the invention has discrete bosses and/or depressions and is easily folded in both the machine direction and the cross-machine direction, and in many other directions as well. As opposed to conventional corrugated board, the paperboard of the invention provides major stiffness in both the machine direction and the cross-machine direction. The embossed paper of the invention is particularly suitable for the production of so-called mini- and micro-corrugated paperboards. The top layer surface of such paperboard is suitable for printing in that it provides a very flat impression.

The embossed paper of the invention may be produced from highly extensible Kraft paper, such as sack paper, at a dry content in the interval of from 50, 60, 70, 80 or 90% up to 95%, whereby the discrete bosses and/or depressions are formed by stretching portions of said paper. The two, three or multi-layer paperboard of the invention may be produced in the same way as ordinary corrugated paperboard, but instead of using a conventional fluted paper, the embossed paper of the invention is used.

### DESCRIPTION OF THE DRAWINGS

FIG. 1 shows an enlarged photograph of a piece of an embodiment of an embossed paper 10 of the invention having bosses 14 and depressions 12. A broken away part on the photograph shows schematically a hard form or roll 20 having depressions 22 and bosses 24 on which the embossed paper 10 has been formed.

FIG. 2 shows a schematic partial perspective view of the hard form or roll 20 comprising the depressions 22 and bosses 24.

FIG. 3a shows a partial sectional view of the hard form or roll 20, partly along the line 3-3 of FIG. 4, with its depressions 22 and bosses 24, a hard counter form or roll 20′ with its matching bosses 24′ and depressions 22′, and an extensible Kraft paper 10′. FIG. 3a shows the parts when no pressure is applied on the hard counter form or roll 20′. FIG. 3b shows the parts when pressure has been applied on hard counter form or roll 20′. The distance between the hard form or roll 20 and the hard counter form 20′ is denoted d.

FIG. 4 shows a partial schematic top view of the hard form or roll 20 with its depressions 22 and bosses 24.

FIG. 5 shows a partial schematic side view of a two layer paperboard, wherein an embossed paper 10 layer is laminated to a layer of a flat paper or paperboard 30.

FIG. 6 shows a partial schematic side view of a three layer paperboard, wherein an embossed paper 10 layer is laminated between two layers of flat paper or paperboard 30.

FIG. 7 shows a partial scheematic side view of a five layer paperboard, wherein two embossed paper 10 layers are laminated between three layers of flat paper or paperboard 30.

FIG. 8 shows a partial schematic top view of a pattern of bosses (open circles) and depressions (circles with dashed lines) of a hard form or roll 20.

### DETAILED DESCRIPTION IF THE INVENTION

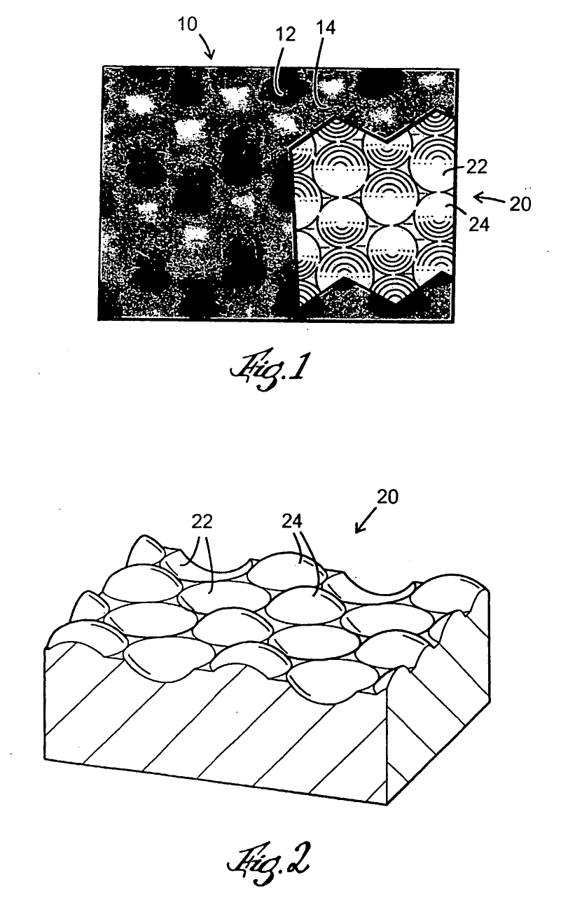

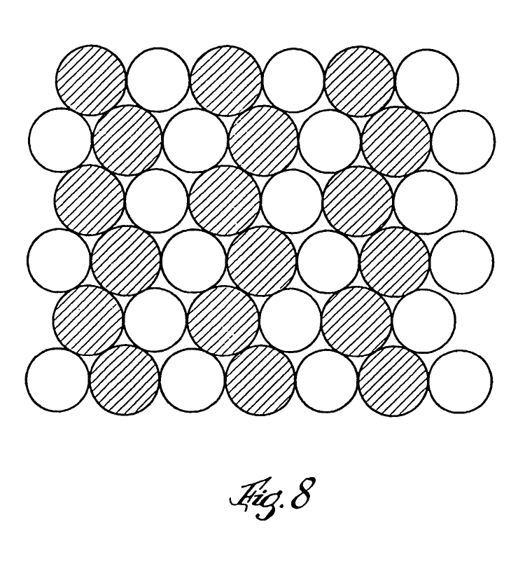

In the following the invention is described with reference to the numbers appearing on the FIGS. 1-8, but it should be understood that the figures only illustrate embodiments of the invention and that the invention is not limited to the illustrated embodiments.

Thus, one aspect of the invention is directed to an embossed paper 10, wherein the paper is a highly extensible Kraft paper 10′and wherein discrete bosses 14 and/or depressions 12 consist of portions of said paper 10′ stretched at a dry content of 50-95%. This means that the outer dimensions of a sheet of the highly extensible Kraft paper 10′ are the same before and after the bosses 14 and/or depressions 12 have been made by stretching discrete parts of the paper 10′ at a dry content of 50-95%, but the surface area of the sheet of paper is increased. The forms of the bosses 14 and/or depressions 12 need not be parts of or half spheres as depicted in the figures, even though such forms are suitable. For instance, they may have the form of parts of or half grains of rice.

In an embodiment of this aspect of the invention the paper has bosses 14 and/depressions 12 that form a repeated pattern (10) covering either or both surfaces of the paper 10 (e.g. as illustrated in FIG. 8).

Such embossed paper of the invention may be used alone as a fancy paper for e.g. carrier bags.

The stretched bosses 14 and/or depressions 12 are rigid, and since the pattern (10) of these preferably avoids the formation of streets, a high flexibility is obtained even though the embossed paper 10 is stiff.

In a preferred embodiment of this aspect of the invention the highly extensible Kraft paper 10′ has an extension of 5% to 30%, and preferably the extension is 10% to 15%. The range of extension is intended to comprise both the extension of the paper in the machine direction and in the cross direction.

The grade of the Kraft paper 10′ is selected from unbleached and bleached, uncoated and coated, one or two or multi ply Kraft paper. Depending on the end use of the embossed paper of the invention, the paper may have a coating that provides a barrier layer or a polymer coating of e.g. polyolefin, preferably polyethylene. The paper may also be impregnated and surface treated with chemicals to resist moisture and/or fat. The coating may be applied on either one or both sides of the paper.

Today, extensible Kraft paper is used for sacks and bags, and such sack paper may be used in the present invention provided it has the required percentage of extension.

In another preferred embodiment of this aspect of the invention the depressions 14 are equally deep and/or the bosses 12 are equally high. This facilitates adherence of the embossed paper to flat paper layers or sheets 30.

The size of the discrete bosses 14 and/or depressions 12 is dependent on the extensibility of the Kraft paper 10′ and the distance between the individual bosses 14 and depressions 12. Larger portions of paper to be stretched to the bosses 14 and depressions 12 are needed when the size of the formed bosses 14 and depressions 12 increase.

In a most preferred embodiment the depth of the depressions 12 and the height of the bosses 14 are in the range of 0.5-4.0 mm and the diameter of the depressions 12 and bosses 14 are in the range of 2.0-10.0 mm.

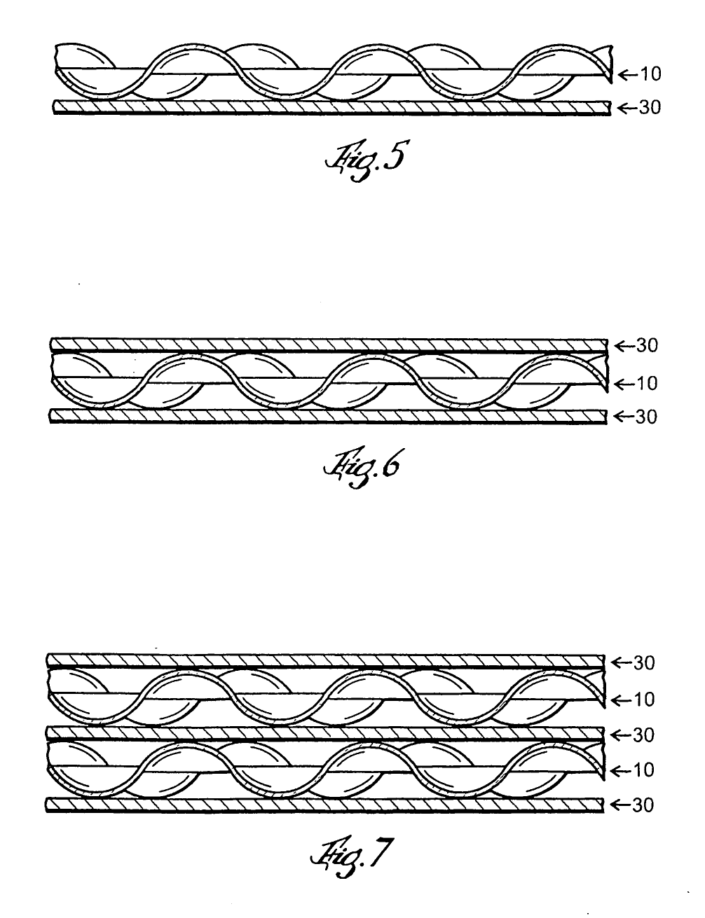

The embossed and/or depressed paper 10 according to the invention is used as a bulking layer in a laminated board (FIGS. 5-7).

Therefore, another aspect of the invention is directed to a two, three or multi-layer paperboard comprising at least one layer of the embossed and/or depressed paper 10 according to the invention.

In a preferred embodiment of this aspect of the invention the paperboard is composed of three layers (FIG. 6) and the middle layer is an embossed and/or depressed paper 10 according to the invention.

The invention is in a further aspect directed to the production of the embossed paper 10 according to the invention. An existing plant producing extensible Kraft paper may be used for the production of the paper. The extensible Kraft paper may be embossed according to the invention either after finished production thereof or as a production step included in the production line after dewatering of the paper web.

According to this aspect of the invention, in a method of producing an embossed paper 10, a highly extensible Kraft paper 10′ having a dry content of 50-95% is pressed against a hard form or roll 20 having depressions 22 and/or bosses 24 to stretch portions of the paper to discrete bosses 14 and/or depressions 12. This means that the outer dimensions of a sheet of the highly extensible Kraft paper 10′ are the same before and after the bosses 14 and/or depressions 12 have been made by stretching discrete parts of the paper 10′ at a dry content of 50-95%, but the surface area of the sheet of paper is increased.

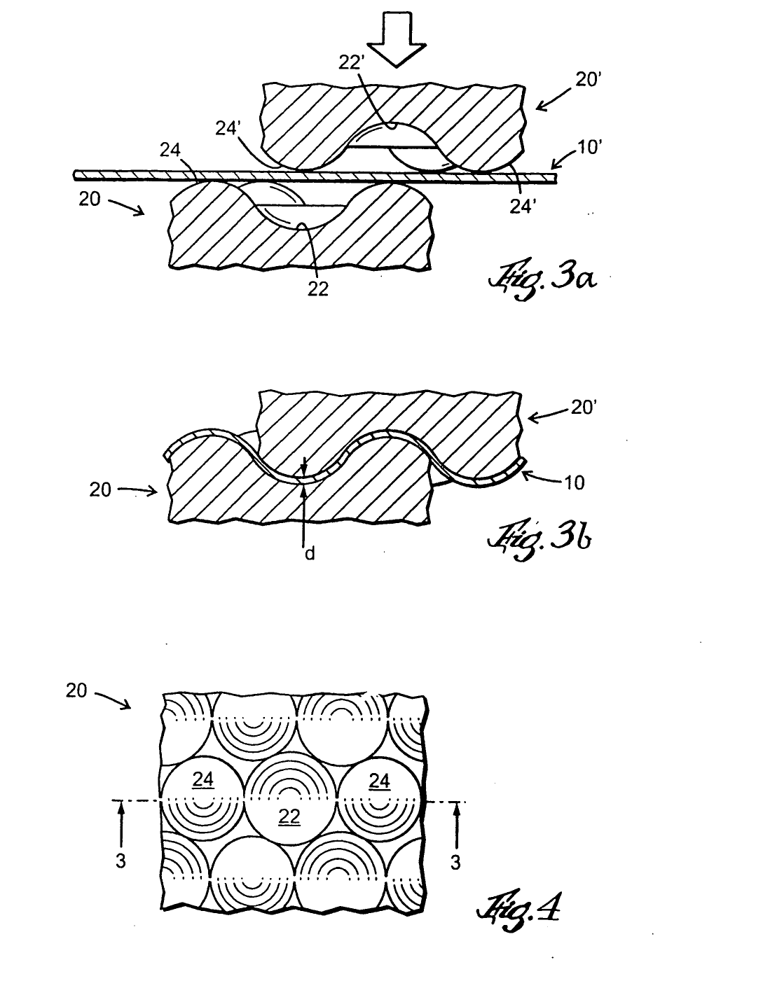

In an embodiment of this aspect of the invention the pressing is performed by applying pressure on the paper 10′ with a hard counter form or roll 20′ with matching bosses 24′ and/or depressions 22′, leaving a gap between the hard form or roll 20 and the counter form or roll 20′, the gap having the dimension of the thickness of the paper 10′ after pressing (FIG. 3b, distance d).

If no gap between the hard form or roll 20 and the hard counter form or roll 20′ would be present, then the paper 10′ would be cut into pieces when the pressure is applied.

In another embodiment the pressing is performed by applying pressure on the paper 10′ with a soft flexible belt, matt or counter roll (not shown). When the pressure is applied on the belt, mat or counter roll, it will follow the contour of the hard form or roll 20, and will take the surface form of the hard counter form or roll 20′. Flexible belts, mats and counter rolls are available on the market, and they are e.g. used in the paper industry as parts in a calender.

In yet another embodiment of this aspect of the invention, the pressure applied on the paper (10′) is in the range of 1.0 MPa to 29.4 MPa (10 to 300 kg/cm²), e.g. 2 MPa to 50 MNa (20 to 50 kg/cm³).

The method of the invention is preferably performed at a temperature in the pressing operation in the range of from room temperature to 350° C. Thus, the temperature is not critical, but may influence the properties of the finished embossed paper 10.

As in the first aspect of the invention, the highly extensible Kraft paper 10′ has an extension of 5% to 30%, and preferably the extension is 10% to 15%. The range of extension is intended to comprise both the extension of the paper in the machine direction and in the cross direction.

The Kraft paper 10′ to be used in the method of the invention is selected from unbleached and bleached, uncoated and coated, one or two or multi ply Kraft paper grades.

The grade of the Kraft paper 10′ is selected from unbleached and bleached, uncoated and coated, one or two or multi ply Kraft paper. Depending on the intended end use of the embossed paper of the invention 10, the paper may have a coating that provides a barrier layer or a polymer coating of e.g. polyolefin, preferably polyethylene. The paper may also be impregnated and surface treated with chemicals to resist moisture and/or fat. The coating may be applied on either one or both sides of the paper.

As already mentioned, extensible Kraft paper is used for sacks and bags, and such sack paper may be used in the present invention provided it has the required percentage of extension.

In another preferred embodiment of this aspect of the invention the depressions 12 are equally deep and/or the bosses 14 are equally high. This facilitates adherence of the embossed paper 10 to flat paper layers or sheets 30.

The size of the discrete bosses 14 and/or depressions 12 is dependent on the extensibility of the Kraft paper 10′ and the distance between the individual bosses 14 and depressions 12. Larger portions of paper to be stretched to the bosses 14 and depressions 12 are needed when the size of the formed bosses 14 and depressions 12 increase.

In a most preferred embodiment the depth of the depressions 12 and the height of the bosses 14 are in the range of 0.5-4.0 mm and the diameter of the depressions 12 and bosses 14 are in the range of 2.0-10.0 mm.

The embossed and/or depressed paper 10 according to the invention may be used as a bulking layer 10 in a laminated board (FIGS. 6, 7 and 8).

Therefore, an additional aspect of the invention is directed to the production of a laminated paperboard wherein the embossed paper 10 of the invention is used as a bulking layer. An existing machine producing corrugated board may be used for the production of the laminated paperboard of the invention. Instead of the fluted paper the highly extensible Kraft paper 10′ can be embossed in the same position in the machine by replacing the corrugating rolls with a hard roll 20 having depressions 22 and/or bosses 24 and a soft counter counter roll or hard counter roll 20′ with matching bosses 24′ and/or depressions 22′.

According to this aspect of the invention, in a process of producing a two, three or multi-layer paperboard, the process comprises a step of laminating at least one layer of the embossed and/or depressed paper 10 according to any one of claims 1-7 to at least one flat paper layer 30.

In a preferred embodiment of this aspect of the invention a three layer paperboard is produced, wherein the middle layer is an embossed and/or depressed paper 10 according to any one of claims 1-7.

Description of a Prototype Embodiment

A flat hard form 20 with bosses 24 and depressions 22 (FIGS. 1-4), and a counter form 20′ with depressions 22′ and bosses 24′ (FIG. 3) were produced with a repeated pattern (FIG. 8).

Bleached Kraft paper of 150 g/m² grammage, dry content of approximately 93%, and an extension of 10-13% (Korsnäs ABC paper) was used as the raw material 10′ in the production of a sheet of embossed paper 10 of the invention (FIG. 1). A pressure of 2.0 MPa (20 kg/cm²) was applied onto the hard counter form 20′, and the temperature was room temperature.

The produced embossed paper 10 had a depth of depressions 12 and a height of bosses 14 of approximately 1.0 mm and the diameter of the depressions 12 and bosses 14 were approximately 2.0 mm.

The same procedure was repeated with a bleached Kraft paper of 150 g/m² grammage with a dry content of approximately 93% and having a 30 g/m polyethylene coating on one side.

1. An embossed paper (10), wherein the paper is a highly extensible Kraft paper (10′) and wherein discrete bosses (14) and depressions (12) consist of portions of said paper stretched at a dry content of 50-95%.

2. The embossed paper according to claim 1, wherein the paper (10) has bosses (14) and depressions (12) that form a repeated pattern (10) covering both surfaces of the paper (10).

3. The embossed paper according to claim 1 or 2, wherein the highly extensible Kraft paper (10′) has an extension of 5% to 30%.

4. The embossed paper according to claim 3, wherein the extension is 10% to 15%.

5. The embossed paper according to any one of claims 1-4, wherein the Kraft paper (10′) is selected from unbleached and bleached, uncoated and coated, one or two or multi ply Kraft paper grades.

6. The embossed paper according to any one of claims 1-5, wherein the depressions (12) are equally deep and the bosses (14) are equally high.

7. The embossed paper according to any one of claims 1-6, wherein the depth of the depressions (12) and the height of the bosses (14) are in the range of 0.5-4.0 mm and the diameter of the depressions (12) and bosses (14) are in the range of 2.0-10.0 mm.

8. A two, three or multi-layer paperboard comprising at least one layer of the embossed and depressed paper (10) according to any one of claims 1-7.

9. The paperboard according to claim 8, wherein the paperboard is composed of three e layers and the middle layer is an embossed and depressed paper (10) according to any one of claims 1-7.

10. In a method of producing an embossed paper (10), a highly extensible Kraft paper (10′) having a dry content of 50-95% is pressed against a hard form or roll (20) having depressions (22) and bosses (24) to stretch portions of the paper to discrete bosses (14) and depressions (12).

11. The method according to claim 10, wherein the pressing is performed by applying pressure on the paper with a hard counter form or roll (20′) with matching bosses (24′) and depressions (22′) leaving a gap between the hard form or roll (20) and the counter form or roll (20′), the gap having the dimension of the thickness of the paper (10′) after pressing.

12. The method according to claim 10, wherein the pressing is performed by applying pressure on the paper (10′) with a soft flexible belt, matt or counter roll.

13. The method according to any one of claims 10-12, wherein the pressure applied on the paper (10′) is in the range of 1.0 MPa to 29.4 MPa (10 to 300 kg/cm²).

14. The method according to any one of claims 10-13, wherein the temperature in the pressing operation is in the range of from room temperature to 350° C.

15. The method according to anyone of claims 10-14, wherein the highly extensible Kraft paper (10′) has an extension of 5% to 30%.

16. The method according to claim 15, wherein the extension is 10% to 15%.

17. The method according to any one of claims 10-16, wherein the Kraft paper (10′) is selected from unbleached and bleached, uncoated and coated, one or two or multi ply Kraft paper grades.

18. The method according to any one of claims 10-17, wherein the depth of the depressions (12) and the height of the bosses (14) are in the range of 0.5-4.0 mm and the diameter of the bosses (14) and depressions (12) are in the range of 2.0-10.0 mm.

19. In a process of producing a two, three or multi-layer paperboard, the process comprises a step of laminating at least one layer of the embossed and depressed paper 10 according to any one of claims 1-7 to at least one flat paper or paperboard layer 30.

20. The method according to claim 19, wherein a three layer paperboard is produced and wherein the middle layer is an embossed and depressed paper 10 according to any one of claims 1-7.
